(19) United States
(12) Patent Application Publication
(10) Pub. No.: US 2021/0341896 A1
(43) Pub. Date: Nov. 4, 2021

(54) INDUSTRIAL MOTOR DRIVES WITH INTEGRATED CONDITION MONITORING

(71) Applicant: Rockwell Automation Technologies Inc., Mayfield Heights, OH (US)

(72) Inventors: Robert J. Miklosovic, Chardon, OH (US); Brian R. Fast, Kirtland, OH (US)

(21) Appl. No.: 16/864,739

(22) Filed: May 1, 2020

(51) Int. Cl. G05B 19/042; G05B 23/02; G06N 20/00

(52) U.S. Cl. CPC G05B 19/0428; G06N 20/00; G05B 23/0283

(57) ABSTRACT

Various embodiments of the present technology generally relate to condition monitoring in industrial environments. More specifically, some embodiments relate to an embedded analytic engine for motor drives. A drive-embedded analytic engine discussed herein enables industrial enterprises, employers, and other users to monitor an industrial operation comprising at least a motor and a mechanical load in order to detect failures before they occur. An embedded analytic engine may perform condition monitoring from within a frequency drive based on a configuration specific to a monitored fault condition. In order to detect fault conditions, the embedded analytic engine may obtain baseline signal data from an industrial operation using rotating machinery, obtain recent runtime signal data from the industrial operation, and use the signal data to produce data light metrics that may be used to detect fault conditions from within the drive.

### BACKGROUND

Industrial drives provide power to motors in automation environments such as factories, mills, and the like. A controller in a motor drive controls the power provided by circuitry in the drive to a given motor based on process signals supplied by upstream control elements (e.g. push buttons or programmable logic controllers).

Condition monitoring is a process of monitoring the condition of the motor and/or its connected mechanical load involved in an industrial process such that the motor drive itself or the upstream control elements can react to potentially damaging faults. Condition monitoring solutions typically monitor machine parameters such as vibration, temperature, and speeds. The parameters may also include voltage and current measurements taken directly from the wiring that connects a drive to a motor.

A condition monitoring solution evaluates the parameters against thresholds to determine whether a fault condition exists and, if so, alerts the drive controller or the upstream control elements. The parameters may be evaluated against pre-programmed thresholds, although some solutions utilize machine learning models in place of, or as a supplement to, thresholding. The machine learning models are trained on historical metrics to recognize when a given parameter is indicative of a looming fault.

Existing condition monitoring is typically performed external to a motor drive. That is, a condition monitoring module resides external to the cabinetry of a drive and gathers its signal data directly from sensors placed on or proximate to the machine or component being monitored. Such configurations introduce added costs and complexity due to the extra hardware and wiring needed to implement the systems.

It is with respect to this general technical environment that aspects of the present technology disclosed herein have been contemplated. Furthermore, although a general environment has been discussed, it should be understood that the examples described herein should not be limited to the general environment identified in the background.

### OVERVIEW

This Overview is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to condition monitoring in industrial environments. More specifically, some embodiments relate to an embedded analytic engine for motor drives. In an embodiment of the present technology, an industrial drive comprises drive circuitry configured to supply power to a motor in an industrial operation, a controller coupled with the drive circuitry and configured to control the power supplied to the industrial operation based at least in part on runtime signal data associated with the motor, and a condition monitoring module. The condition monitoring module, in the present embodiment, is configured to obtain the runtime signal data from the controller and monitor one or more fault conditions of the industrial operation based on metrics comprising runtime measurements derived from the runtime signal data and baseline metrics derived from baseline signal data, wherein monitoring one or more fault conditions of the industrial operation comprises monitoring one or more fault conditions of the motor and/or the connected mechanical load.

In some implementations, the condition monitoring module of the present embodiment is further configured to identify a fault condition, of the one or more fault conditions, to be monitored, derive the runtime metrics from the runtime signal data based on settings specific to the fault condition, and derive the baseline metrics from the baseline signal data based on the settings. The settings specific to the fault condition may comprise one or more of filter settings, time domain parameters, frequency domain parameters, transform settings, pattern recognition settings, and frequency response settings. The condition monitoring module may be further configured to obtain the baseline signal data prior to obtaining the runtime signal data, store the baseline signal data in the industrial drive, and synchronize the baseline signal data with the runtime signal data. When a new motor or connected mechanical component replaces an existing worn motor or connected mechanical component, the condition monitoring module may obtain new baseline signal data, store the new baseline signal data in the industrial drive, and synchronize the new baseline signal data with the runtime signal data. The runtime metrics and the baseline metrics are supplied to a detection engine to detect a presence of the one or more fault conditions. In some implementations, to monitor the one or more fault conditions of the industrial operation, the industrial drive is configured to generate differential metrics based on the runtime metrics and the baseline metrics and supply at least the differential metrics to a detection engine to detect a presence of the one or more fault conditions. The detection engine, in certain implementations, may comprise at least one machine learning model configured to classify a condition of the industrial operation based on the differential metrics.

In another embodiment, one or more computer-readable storage media have program instructions stored thereon to perform condition monitoring in an industrial automation environment. The program instructions, when read and executed by a processing system, direct the processing system to at least, in a motor drive configured to supply power to a motor in an industrial operation, obtain runtime signal data from one or more sensors associated with the industrial operation, derive runtime metrics from the runtime signal data based on settings specific to a fault condition of the industrial operation, and monitor the fault condition of the industrial operation. A fault condition of the industrial operation may include a fault condition associated with the motor and/or a fault condition associated with a connected mechanical load. Monitoring the fault condition of the industrial operation is based on metrics comprising the runtime metrics derived from the runtime signal data and baseline metrics derived from baseline signal data in the present embodiment.

In yet another embodiment, a method of condition monitoring in an industrial automation environment comprises obtaining runtime signal data from a controller configured to control power supplied to a motor in an industrial operation based at least in part on the runtime signal data associated with the industrial operation, deriving runtime metrics from the runtime signal data based on settings specific to a fault condition of the industrial operation, and monitoring the fault condition of the industrial operation based on metrics comprising the runtime metrics derived from the runtime signal data and baseline metrics derived from baseline signal data. In the present embodiment, the fault condition may be a fault condition of the motor or a fault condition of an associated mechanical load.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an industrial automation environment including an embedded analytic engine in accordance with some embodiments of the present technology;

FIG. 2 illustrates an industrial process associated with an embedded analytic engine in accordance with some embodiments of the present technology;

FIG. 3 illustrates a high-level overview of a system architecture of an embedded analytic engine in accordance with some embodiments of the present technology;

FIG. 4 illustrates an exemplary architecture of an embedded analytic engine in accordance with some embodiments of the present technology;

FIG. 5 illustrates an exemplary architecture of an embedded analytic engine in accordance with some embodiments of the present technology;

FIG. 6 illustrates a series of steps for monitoring a condition of an industrial operation in accordance with some embodiments of the present technology;

FIG. 7 illustrates a series of steps for monitoring a condition of an industrial device in accordance with some embodiments of the present technology;

FIG. 8 illustrates a series of signals associated with an industrial machine and common faults associated with the machine in accordance with some embodiments of the present technology;

FIG. 9 illustrates an industrial automation environment comprising a plurality of levels from which conditions may be monitored in accordance with some embodiments of the present technology; and

FIG. 10 illustrates a computing device that may be used in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the present technology generally relate to condition monitoring in industrial environments. More specifically some embodiments relate to an embedded analytic engine for motor drives. While the analytic engine of the present disclosure is discussed in reference to rotating machinery and motor drives, the technology may be applied to any industrial device to monitor signals other than those discussed herein. In rotating machinery, condition monitoring may refer to monitoring the health of a drive motor, the health of a mechanical load, or both. Condition monitoring plays an important role in industrial processes, as it enables predicting motor and load failures in rotating machinery. High-speed drive signals are sent to a programmable logic controller (PLC) at much lower data rates than they are captured and, as a result, there is loss of information without a simple means to transfer the high-speed data. Thus, embodiments herein include a general-purpose embedded drive analytic engine that applications for detecting specific fault conditions may be built on top of. An industrial process, as used in the present disclosure, may include any system comprising one or more industrial operations.

Existing technology does not provide a simple mechanism by which industrial enterprises, facilities, devices, or similar may monitor the health of rotating machinery without requiring multiple hardware components, sensors, and cabling in addition to complex configurations of several parameters across a plurality of software packages. These factors cause set up of such a system to be expensive and time-consuming. Other disadvantages of existing solutions include that they are only suitable for single-drive applications and not suitable for PLC system-level analytics. Furthermore, they do not work in stand-alone applications that do not have communication to external systems. In the industry, there is an overall lack of integrated solutions and configurability, contributing to a need for a simpler, streamlined solution that enables condition monitoring for rotating machinery without excessive costs.

Two important instruments associated with motor control include the variable frequency drive (VFD) and the PLC. VFDs may be used to supply power to motor driven loads, allowing them to operate within a wide range of speeds (i.e., an infinite number of speeds within the operating range). VFDs may control position, speed, torque, acceleration, direction of rotation, and similar variables associated with a rotating machine. The use of VFDs can greatly increase efficiency in a variety of industrial systems such as pump, compressor, conveyor, crane, and fan systems. A PLC is a program-based computer used in motor control systems, typically to synchronize the motion across multiple drives.

Thus, a general-purpose, configurable analytic engine embedded in a motor drive (i.e., a VFD) is disclosed. An analytic engine in accordance with the present disclosure may include an application layer that hides configuration complexity and simplifies a user's experience. The analytic engine may be configured to monitor various applications and detect degradation of a motor or its detected mechanical load early on. In the process, the analytic engine extracts application specific information from data at the data source. Results in accordance with the present technology are information rich and data light. The results can be easily sent through a network to an associated PLC or may easily be sent through a gateway to an external computing environment (e.g., a cloud) without loss of information, network congestion, and without requiring high-speed data transfer. Data heavy signals are converted to data light information for network transport and may be used for detection at all levels of an industrial environment as a result.

A drive-embedded analytic engine in accordance with the present disclosure enables industrial enterprises, employers, and other users to monitor a motor and connected load in order to detect failures before they occur. Predicting electrical, motor-mechanical, and load-mechanical fault conditions before they happen may serve to prevent unscheduled downtime and reduce spare parts inventory, for example. Various high-speed, data heavy drive signals may be configured, measured, and analyzed within the drive without requiring additional hardware and wiring and without loss of information. Analytic measurements and outputs of the engine are information rich and data light and, as a result, can be sent through a network to a PLC controller or through a gateway to a cloud environment for purposes of display, aggregation, and further analysis without bogging down the network. These advantages allow analytic algorithms in a PLC to predict faults that occur across systems with multiple drives and sensors.

As previously mentioned, condition monitoring as discussed herein may be used to detect failure conditions of rotating machinery. Condition monitoring may be performed within the drive (i.e., the VFD) via frequency analysis of phase currents and other drive signals. Known failures associated with motors and mechanical loads may be related to mechanical components of a machine, vibrations, electrical components, and similar aspects of rotating machinery. Certain failures cannot be detected at the controller or cloud level because they may use high speed data and memory. Thus, the present technology enables failure detection from within the drive. The present technology may be used to detect failures of bearings, rotor bars, shafts, windings, oil whirl and whip, rolling elements, gears, teeth, comparators, connectors, or similar componentry associated with rotating machinery. The present technology may detect problems including misalignment, unbalance, instability, resonance, wear, damage, degradation, buildup, cracking, bending, breaking, blade pass, vane pass, backlash, blockages, load, looseness, turbulence, rub, eccentricity, phase problems, phasing problems, current, tuning problems, or cavitation and blockage, in addition to other problems associated that may be with rotating machinery. The present technology may be used for vibration monitoring, monitoring of induction motor faults, or monitoring of pumps, fans, blowers, compressors, conveyors, cranes, and hoists, in addition to other equipment employing a motor drive.

Condition monitoring, in accordance with the present technology, includes four foundational steps: input selection, data acquisition, feature extraction, and detection. Input selection includes selecting the input signal source, such as signals from vibration, temperature, or acoustic sensors or drive signals like phase current and voltage, torque reference, or velocity feedback that may be used in accordance with fault condition monitoring settings for a given scenario. Data acquisition includes capturing data from the selected signals that is related to the fault condition monitoring settings. Feature extraction includes converting the captured data content, including high speed data content, to information content (i.e., metrics), which may be fast information content in some implementations. Converting data content to information content may include the utilization of frequency domain techniques such as fast Fourier Transform (FFT) algorithms, time domain techniques such as extracting average, minimum, maximum, and root mean square (RMS) information, or other transform techniques to extract pattern recognition, correlation, or variance information. The fourth step, detection, is applied to the extracted information to enable the detection of fault conditions. Fault conditions may be detected using thresholds and technology for identifying when thresholds are exceeded. Detection may additionally or alternatively include machine learning (ML) techniques to predict and detect failures by categorizing conditions or by similar statistical means.

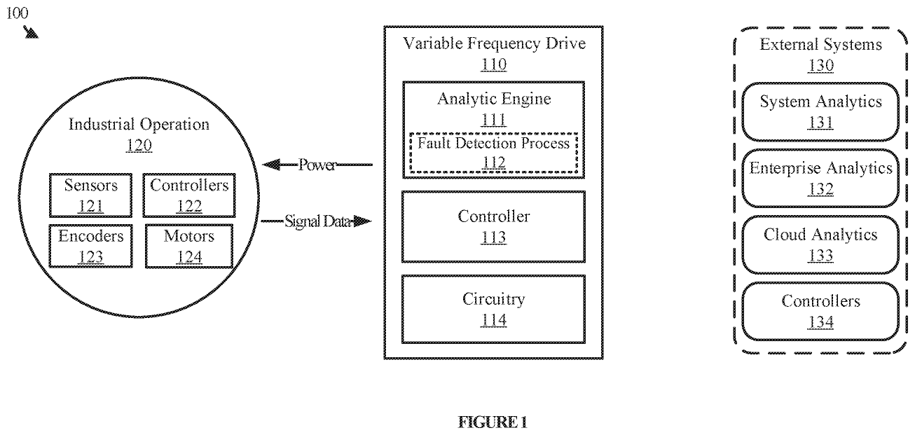

FIG. 1 illustrates an example of an industrial environment in which aspects of the present technology may be implemented. Environment 100 includes variable frequency drive 110, industrial operation 120, and external systems 130. Variable frequency drive 110 includes analytic engine 111, controller 113, and circuitry 114. Industrial operation 120 includes sensors 121, PLC automation controllers 122, encoders 123, and motors 124. External systems 130 includes system analytics 131, enterprise analytics 132, cloud analytics 133, and PLC automation controllers 134. Industrial operation 120 may represent any industrial machine or system powered by variable frequency drive 110. The components of variable frequency drive 110 and industrial operation 120 may differ depending on a given implementation. Systems shown herein may include additional components, fewer components, and different components and may still be in accordance with the technology of the present example. Likewise, sensors 121, PLC automation controllers 122, and encoders 123 may each represent any number of sensors, controllers, and encoders, respectively, associated with industrial operation 120. External systems 130 serves to represent or include any layer of an industrial automation environment external to variable frequency drive 110, wherein the external analytics may collect and analyze data from analytic engine and/or separately from analytic engine 111 and perform system analytics.

Variable frequency drive 110 supplies power to motors 124 of industrial operation 120 and receives signal data from industrial operation 120. Analytic engine 111 runs fault detection process 112 to detect faults within industrial operation 120 based on the signal data. Analytic engine 111 is a configurable analytics processor that provides flexibility for condition monitoring and includes an application layer that hides complexity and simplifies the user experience for individual applications and fault detection. Analytic engine may be configured to monitor various applications and detect degradation or other faults of a motor and a connected mechanical load from industrial operation 120.

Although analytic engine 111 may be in communication with any analytics system of external systems 130, analytics engine 111 does not require external systems to perform condition monitoring in accordance with the technology disclosed herein. To perform condition monitoring within the drive, analytic engine 111 may implement fault detection process 112 independently from external systems 130. However, in some examples, externals systems 130 may be in communication with analytic engine 111, components of industrial operation 120, or combinations thereof and external systems 130 may perform condition monitoring independently of analytic engine 111 or based on data from analytic engine 111.

In some examples, an enterprise may use analytic engine 111 as one component of a greater condition monitoring and analysis system within the enterprise. A modular topology may utilize analytic engine 111 at the device level in addition to processes and analyses performed at the system and enterprise level. At the device level, analytic engine 111 may collect data from devices of industrial operation 120 and other sources in various formats. Analytic engine may use collected data to perform condition monitoring, power and energy monitoring, predictive life analysis, load characterization, or similar analyses. At the system level, system analytics 131 may aggregate and contextualize information to detect system level fault conditions and/or provide insights related to preventative maintenance, energy diagnostics, system modeling, performance optimization, and similar insights. At the enterprise level, enterprise analytics, cloud analytics, or a combination thereof may present information to users on devices and systems including mobile devices and desktop computers to enable remote learning, machine learning, and root cause analysis.

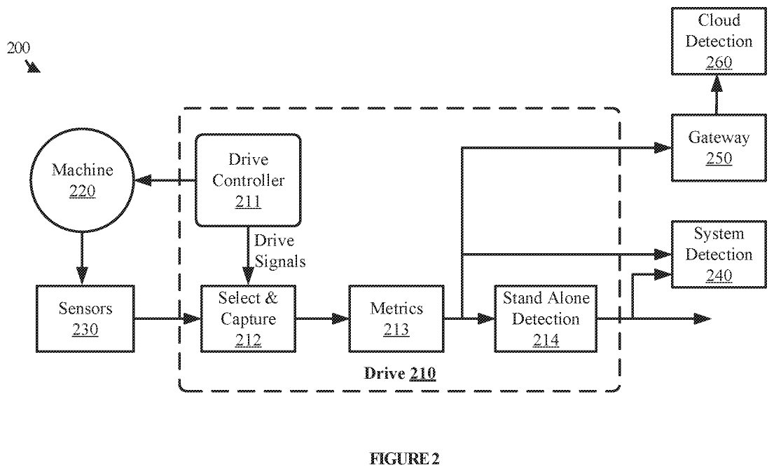

FIG. 2 illustrates an example of a condition monitoring environment for fault detection at the drive level. Environment 200 includes drive 210 representative of a variable frequency comprising an analytics engine such as drive 110. Components of drive 210 serve to represent functionality of a drive comprising an analytics engine for device-level condition monitoring. Drive controller 211 provides an output supplied to machine 220, which may be representative of any motor-driven industrial operation including industrial operation 120. Sensors 230 may include vibration, temperature, acoustic, or other external sensors that collect data related to operation of machine 220 and provide the data to select and capture module 212. Select and capture module 212 collects data from a drive signal or sensors 230, depending on what signal is selected, and provides the captured data to metrics module 213. Select and capture module 212 is used during baseline and runtime captures. Metrics module 213 processes the data to generate metrics data that can be utilized for fault detection. The data collected by select and capture module 212 and the processing performed by metrics module 213 may, in some embodiments, depend on settings specific to one or more fault conditions being monitored. For example, for a given fault condition, settings may change which drive signal is selected to capture in select and capture module 212 as well as the manner in which metrics module 213 processes the data by changing signal paths to implement various filters and algorithms, performing measurements, utilizing specific parameters, or other settings that may affect processing to produce metrics specific to a fault condition. Metrics are calculated independently for baseline and runtime captures and then differences are calculated between them. Metrics may then be output by metrics module 213 and provided to one or more systems and modules for condition monitoring. A fault condition in accordance with the present example may include a fault condition associated with the motor or a fault condition associated with an associated mechanical load.

The output of metrics module 213 is provided to stand alone detection module 214 which may then use the metrics produced by metrics module 213 to perform fault detection within drive 210. Standalone detection, in some examples, comprises determining if one or more fault conditions is present based on the settings specific to at least one fault being monitored. Detection methods include thresholding or machine learning. In addition to supplying the metrics to stand alone detection module 214, metrics may be provided to additional systems for condition monitoring or other purposes. In the present example, metrics are provided to system detection module 240 for system-level fault detection. Metrics are also provided to gateway 250 and ultimately to cloud detection module 260 for enterprise-level fault detection. Metrics may be provided to additional systems or locations. Similarly, stand alone detection module 214 may provide detection results to one or more external locations including system detection module 240. Stand alone detection module 214 may provide results to gateway 250, cloud detection module 260, or any other system in communication with stand alone detection module 214.

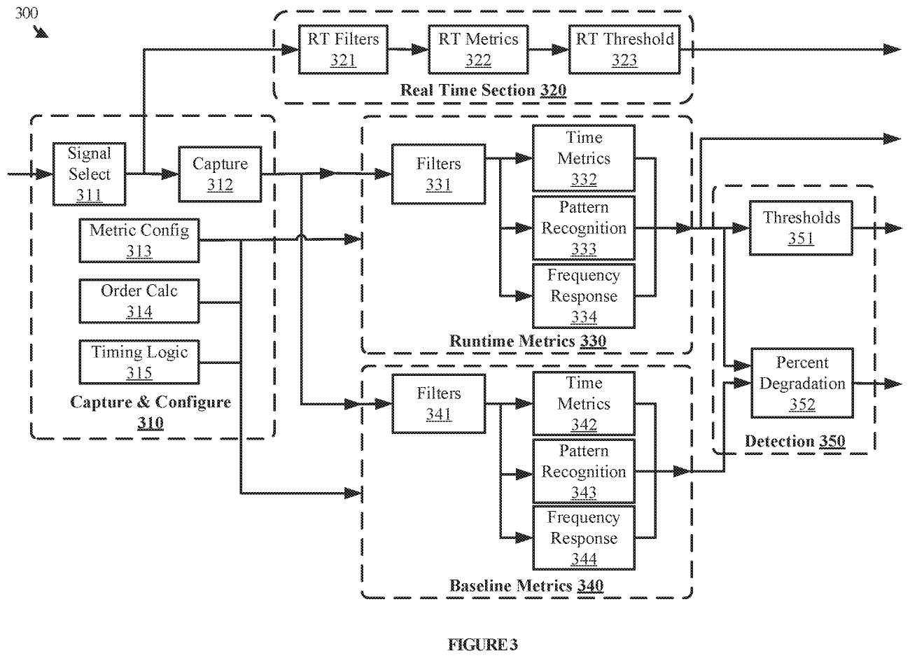

FIG. 3 includes a high-level diagram of the architecture of a configurable core processor for performing condition monitoring in a drive in accordance with some embodiments of the present technology. The drive in which the configurable core processors resides is at least one of the drives supplying power to an industrial operation, wherein the industrial operation includes at least a motor and a connected mechanical load. The condition monitoring performed by the processor in the drive may include monitoring for conditions associated with the motor, conditions associated with the connected mechanical load, and variations or combinations thereof. Architecture 300 includes capture and configure section 310, real time section 320, runtime metrics section 330, baseline metrics section 340, and detection section 350. The configurable analytics processor of the present example may be employed within a variable frequency drive and serves to, at least in part, convert data heavy signals to data light information suitable for network transport and detection at all levels of an industrial enterprise. Capture and configure section 310 comprises signal select 311, capture 312, metric configurations 313, order calculations 314, and timing logic 315. Signal select 311 may select input data based on one or more fault conditions to be monitored. Selectable inputs may include motor current and voltage, data from external connected sensors, internal drive signals (including signals generated from local digital twin models), and additional inputs and signals related to function of an industrial operation. Capture 312 may collect the selected data for condition monitoring while metric configurations 313, order calculations 314, and timing logic 315 may provide inputs and settings to metrics sections for producing metrics specific to the one or more fault conditions being monitored. Order calculations 314 allow filters 331, filters 341, frequency response 334, and frequency response 344 to track changing mechanical speed or changing electrical frequency (speed). Frequency responses may rescale the frequency vector as a function of a changing speed, allowing magnitudes and phases to not shift in frequency during variable speed operation of the drive.

Outputs of capture and configure section 310 further include feeding the selected signals directly to real time section 320. Real time section 320 includes real time filters 321, real time metrics 322, and real time threshold 323. Once the appropriate filters, metrics, and thresholds have been applied to process the real time signals, real time output may be provided in addition to other outputs of the processor. The real time channel provides high speed (i.e., fast) fault detection for protection situations.

Metrics are signals that are much smaller than the signals going into capture and configure section 310. The smaller signals are able to be sent through a network without loss of information and/or network congestion and sending the metrics does not require high speed data transfer. Runtime metrics section 330 and baseline metrics section 340 convert data heavy signals to data light metrics that may be used to detect fault conditions within the drive. Fault conditions may include faults associated with the motor of an industrial operation and faults associated with a mechanical load of the industrial operation. The data light metrics further enable data to be communicated to external systems for fault detection or other monitoring purposes. Runtime metrics section 330 produces metrics from recent data according to settings specific to the one or more fault conditions being monitored. Baseline metrics section 340 produces baseline metrics from baseline data for purposes of determining percent degradation and similar metrics that may address changes in function. Baseline metrics may be collected whenever the machine or industrial operation is running under healthy operating conditions, such as when a new device or component is installed, such that recent metrics can be compared to how the system functioned initially.

Runtime metrics section 330 includes filters 331, time metrics 332, pattern recognition 333, and frequency response 334. Baseline metrics section includes filters 341, time metrics 342, pattern recognition 343, and frequency response 344. The modules included in architecture 300 may represent different numbers of physical components depending on a specific implementation. Each of runtime metrics section 330 and baseline metrics section 340 may independently apply simultaneous measurements to input signals. Simultaneous measurements and metrics produced may include filtering, time domain metrics, frequency domain metrics, and pattern domain metrics. Time and frequency domain metrics may include metrics such as signal average, signal normalization, signal maximum, signal minimum, RMS, band limited frequency responses, variance and covariance, correlation and cross correlation in addition to various filters and pattern recognition modules. A pattern recognition technique having a small computational footprint may be applied in some implementations. A pattern recognition technique used in accordance with the present example may be fast and require little processing power. The metrics produced by runtime metrics section 330 and baseline metrics section 340 are configurable such that analytics may be produced for any application including fault detection and condition monitoring. Settings may differ within each section or within modules of each section depending on which fault condition is being monitored.

Metrics are then provided to detection section 350 comprising thresholds 351 and percent degradation 352 in addition to any other specified output locations such as additional condition monitoring modules within the drive or external systems. Differences may then be calculated between baseline metrics and the recent metric calculations. Percent degradation 352 may utilize a detection method that determines the percent of degradation between the baseline metrics and the recent metrics. Percent degradation may be communicated to other modules or systems. Differences are also combined in a configurable, weighted sum difference allowing application-dependent information to be represented by a single number. Thresholds 351 may perform a variety of different condition monitoring functions including determining whether any measurements or metrics exceeded thresholds indicating an unhealthy state. Specific thresholds may be set to show when metrics exceed predetermined values. The outputs of differences and thresholds are averaged over a specified number of detection cycles to mitigate noise and other undesirable instantaneous effects. Condition monitoring information may then be communicated to other modules or systems in some examples. Detection section 350, in some examples, may display measurements, differences, or percent degradation. Differences and percentages may be displayed to give users a real-time or near real-time indication of the amount of mechanical and electrical degradation over time.

In some examples, one or more modules of detection section 350 may apply machine learning techniques to predict faults within the system. Similarly, machine learning methods may be utilized within a detection module at the system level to predict system level faults across connected systems with multiple drives and sensors. In certain implementations, an artificial intelligence computer module is utilized in the PLC rack and applies machine learning technology to predict faults.

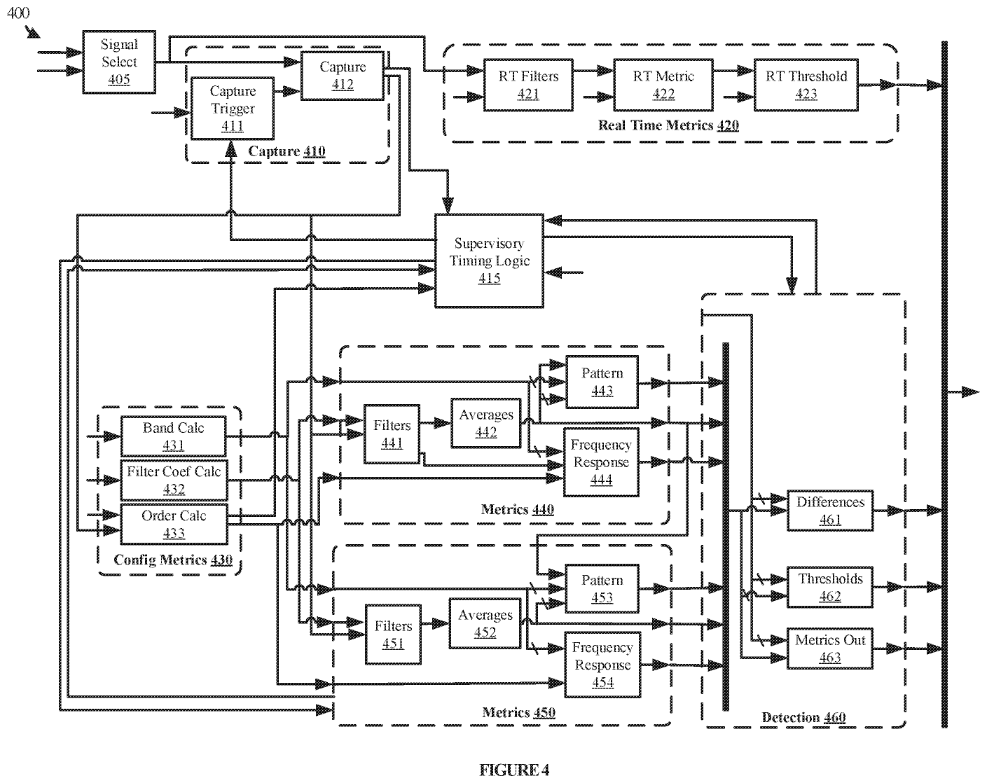

FIG. 4 illustrates a detailed diagram illustrating an exemplary design of an embedded analytics engine for motor drives in accordance with some embodiments of the present technology. Each of the components, modules, groupings, and relationships are shown for purposes of illustration and do not intend to limit the actual number or groupings of components used to implement an embedded analytics engine disclosed herein. The embedded analytics engine of the present example may reside in a motor drive that supplies power to an industrial operation, wherein the industrial operation comprises at least a motor and a connected mechanical load. The embedded analytics engine may then be used to monitor fault conditions of the industrial operation, including fault conditions of the motor, the mechanical load, and variations or combinations thereof. Analytics engine 400 comprises many similar components to architecture 300 from FIG. 3, however it provides more detail regarding the interconnection of supervisory timing logic 415. In some examples, some components of architecture 300 and analytics engine 400 may be the same. Analytics engine 400 includes capture 410, supervisory timing logic 415, real time metrics 420, configure metrics 430, metrics 440, metrics 450, and detection 460.

Similar to the previous example, signal select 405 selects runtime signals to be used for condition monitoring by the analytics engine. Selected signals may then be captured by capture 412 and additional signals may be captured by capture trigger 411 and provided to capture 412. Capture 412 provides captured data to supervisory timing logic 415, real time filters 421, and order calculations 433. Real time filters 421 may also receive selected signals directly from signal select 405 for high speed fault detection for protection situations. Real time metrics 420 includes real time filters 421, real time metrics 422, and real time threshold 423. Once the appropriate filters, metrics, and thresholds have been applied to process the real time signals, real time output may be provided in addition to other outputs of the processor. The real time channel provides high speed (i.e., fast) fault detection for protection situations.

Supervisory timing logic 415 may provide timing logic to various modules throughout analytics engine 400 including but not limited to capture trigger 411, metrics 450, detection 460, and additional locations in some embodiments. Supervisory timing logic 415 also receives timing information from capture 412, metrics 450, order calculations 433, detection 460, and additional timing configuration locations in some embodiments. The main task of supervisory timing logic 415 is to continuously sequence through the capture, metrics, and detection cycle, starting each task when the previous tasks that feed it are complete. When detection is complete, another capture is initiated after an optional pre-programmed wait time. Supervisory timing logic 415 also allows baseline metrics to be recalculated on a captured baseline signal stored in memory when any configure metrics (i.e., from configure metrics 430) change.

Configure metrics 430 includes band calculations 431, filter coefficient calculations 432, and order calculations 433. The modules and calculations of configure metrics 430 apply settings to metrics 440 and metrics 450 that determines how signals will be processed to produce metrics according to one or more fault conditions to be monitored, wherein fault conditions may include fault conditions associated with a motor and/or a connected mechanical load of an industrial operation to which the drive supplies power. Modules of configure metrics 430 may provide information to metrics 440 and metrics 450 related to how to process signals including determining which filter types to use, filter settings and coefficients, algorithms and algorithms settings, and other information that may affect how metrics are generated for the one or more fault conditions. Band calculations 431 calculates frequency bin vectors that are used to generate multiple band limited frequency responses in frequency response 444 and 454. When a different fault condition is being monitored, the settings within metrics 440 and metrics 450 change as controlled by configure metrics 430 based on the fault condition.

Metrics 440 includes filters 441, averages 442, pattern 443, and frequency response 444, each of which may comprise a plurality of components for processing signals to produce metrics including filtering, measurements, calculations, pattern recognition, frequency response analysis, and other means of processing relevant information. Metrics 450 includes filters 451, averages 452, pattern 453, and frequency response 454, each of which may comprise a plurality of components for processing signals to produce metrics including filtering, measurements, calculations, pattern recognition, frequency response analysis, and other means of processing relevant information. In some embodiments, metrics 440 processes recent runtime signal data and metrics 450 processes baseline signal data. Each of metrics 440 and metrics 450 may apply a plurality of filters, bandpass filters, algorithms, and other measurements or models to signal data to produce metrics that can be used for fault detection according to the configurations provided by configure metrics 430. Each of metrics 440 and metrics 450 includes a plurality of bus selectors that may be configured according to configure metrics 430. Outputs of metrics 440 and metrics 450 may then provide metrics to detection 460.

Detection 460 includes differences 461, thresholds 462, and metrics out 463. The modules of detection 460 may utilize the metrics provided to detection 460 to identify unhealthy operating conditions, degradation, differences, exceeded thresholds, or the like. In some examples, differences are combined in a configurable weighted sum difference and then provided to thresholds 462. In other examples, detection 460 may use machine learning techniques to identify fault conditions or when faults are likely to occur before they happen. Detection 460 also includes a plurality of bus selectors that may be configured to process metrics in a certain way by configure metrics 430. Data from detection 460 may then be output to various places including external detection modules at the system or enterprise level.

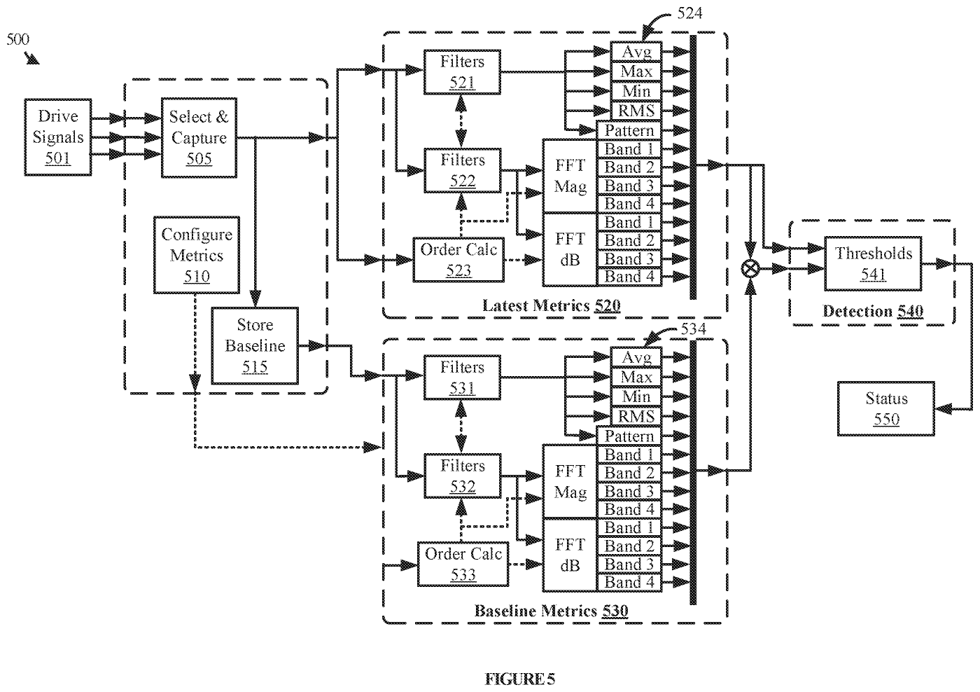

FIG. 5 illustrates an additional example of a system architecture for an embedded analytic engine for a motor drive. Analytic engine 500 receives drive signals 501 from a device or system comprising rotating machinery powered by the motor drive and associated sensors. Select and capture 505 selects and captures signals from drive signals 501 and provides the signals to store baseline 515, filters 521, and order calculation block 523. Configure metrics 510 may provide configurations for latest metrics 520, baseline metrics 530, or both. Store baseline 515 may store baseline signal data so that metrics may be recalculated via baseline metrics 530 when changes are made to parameters and settings in configure metrics 510. This allows the original baseline signal to be used without requiring a new baseline to be captured a period of time after the machine has degraded from healthy conditions. In this manner, settings and operations of analytic engine 500 are configurable even after baseline data has been collected.

Latest metrics 520 is provided the latest signals captured during runtime including during both healthy and unhealthy conditions. Latest metrics 520 includes filters 521, filters 522, and order calculation block 523. Filters 521 and filters 522 allow for separate filtering of signals supplied to operations 524. Order calculation block 523 calculates order based on mechanical rotor frequency (speed) or electrical stator frequency. Operations 524 includes a plurality of filters, algorithms, measurements, and similar processing components that may be utilized and configured according to settings associated with a fault condition. Operations 524 may include frequency domain metrics, such as multiple band limited FFT calculations in units of normalized magnitude and in units of decibels. Operations 524 may include time domain metrics to calculate averages, maximums, minimums, RMS, pattern recognition, correlation, variance, and similar time domain measurements. Latest metrics 520 may then provide the calculated metrics as output. The output may be provided directly to detection 540 and also used to determine a difference between the latest metrics and the baseline metrics, which may then be provided to detection 540. In some examples, the differences are combined in a configurable weighted sum difference.

Similarly, baseline metrics 530 is provided baseline signals captured during healthy conditions. Baseline metrics 530 includes filters 531, filters 532, and order calculation block 533. Filters 531 and filters 532 allow for separate filtering of signals supplied to operations 534. Order calculation block 533 calculates order based on mechanical rotor frequency (speed) or electrical stator frequency. Operations 534 includes a plurality of filters, algorithms, measurements, and similar processing components that may be utilized and configured according to settings associated with a fault condition. Operations 534 may include frequency domain metrics, such as multiple band limited FFT calculations in units of normalized magnitude and in units of decibels. Operations 534 may include time domain metrics to calculate averages, maximums, minimums, RMS, pattern recognition, correlation, variance, and similar time domain measurements. Baseline metrics 530 may then provide the calculated metrics as output. The output may be provided directly to detection 540 and also used to determine a difference between the latest metrics and the baseline metrics, which may then be provided to detection 540. In some examples, the differences are combined in a configurable weighted sum difference.

The outputs are then used to determine a difference between the metrics and provided to thresholds 541 in detection 540. Detection 540 may process output information to determine percent degradation and other measurements relevant to condition monitoring for a given fault condition. In some examples, thresholds 541 compares metrics and differences against predetermined thresholds to identify if any metrics exceed thresholds for healthy conditions. In other examples, detection 540 may implement machine learning techniques to recognize healthy or unhealthy conditions based on the metrics. Detection 540 may then provide the information as output to indicate a status of the device or system with status 550. Detection 540 may further provide the information to additional systems for external condition monitoring, reporting, or the like.

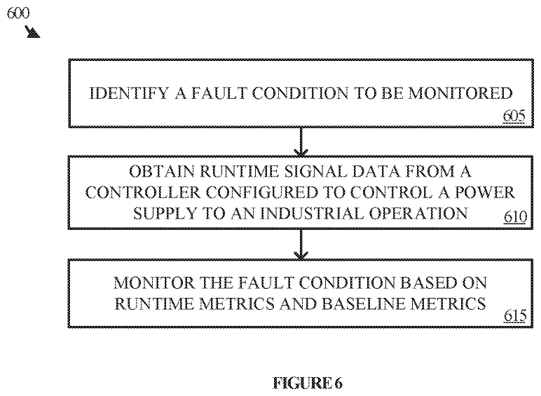

FIG. 6 is a flow chart illustrating process 600 for monitoring fault conditions with an embedded analytic engine for VFDs. In step 605, the embedded analytic engine identifies a fault condition to be monitored. A fault condition may be provided by settings configured by a user. In response to identifying a fault condition, the embedded analytic drive may configure components and modules of the drive for processing signal data and monitoring the signal data. In step 610, the analytic engine obtains runtime signal data from a controller configured to control a power supply to an industrial operation. The controller may be an explicit component of the VFD in some examples. The runtime signal data may be collected from one or more sensors associated with the industrial operation and obtained by one or more components of the VFD.

The collected signal data may then be utilized by the embedded analytic engine to monitor the fault condition based on runtime metrics and baseline metrics in step 615. Processing signal data and identifying fault conditions is described in detail with reference to the preceding Figures and is not discussed at length here for purposes of brevity. Baseline metrics are collected during healthy operating conditions and stored to be used during condition monitoring in step 615. The steps included in process 600 are not intended to limit condition monitoring technology as described herein and are provided solely for purposes of explanation.

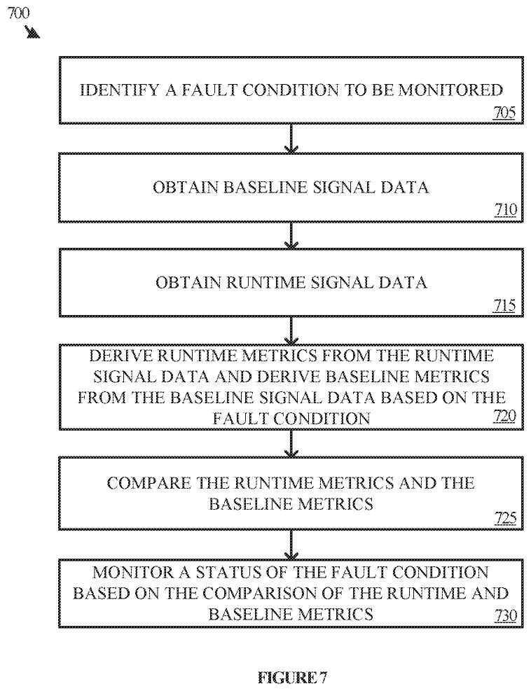

FIG. 7 is a flow chart illustrating process 700 for operating an embedded analytic engine in accordance with some embodiments of the present technology. In step 705, the analytic engine identifies a fault condition to be monitored. A fault condition may be provided by settings configured by a user. In response to identifying a fault condition, the embedded analytic drive may configure components and modules of the drive for processing signal data and monitoring the signal data. In step 710, the analytic engine obtains baseline signal data during healthy operating conditions. Baseline signal data may be obtained from one or more locations associated with an industrial operation including the motor drive in which the analytic engine is embedded and/or sensors associated with the industrial operation.

In step 715, the analytic engine obtains runtime signal data. Runtime signal data may be obtained from one or more locations associated with an industrial operation including the motor drive in which the analytic engine is embedded and/or sensors associated with the industrial operation. In step 720, the analytic engine derives runtime metrics from the runtime signal data and derives baseline metrics from the baseline signal data based on the identified fault condition. Deriving runtime metrics and baseline metrics is described in detail in reference to some of the preceding Figures and is therefore not described at length here. After deriving the runtime metrics and baseline metrics, the analytic engine compares the runtime metrics and baseline metrics in step 725. Comparisons may be performed in a variety of manners including but not limited to calculating differences, determining percent degradation, comparing metrics to threshold values, applying machine learning techniques to identify unhealthy conditions, and the like. The analytic engine uses the comparisons to monitor a status of the fault condition based on the comparison of the runtime metrics and the baseline metrics.

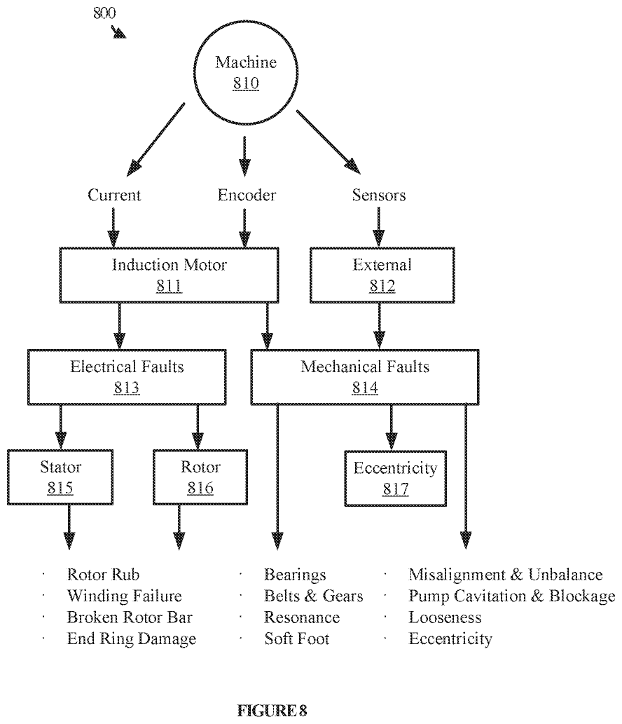

FIG. 8 illustrates an example of how faults may be detected for a machine based on the different sources of information. Fault detection environment 800 includes machine 810, which may output information through motor current and voltage, encoders, and sensors. Currents and encoders may provide information related to induction motor 811 of machine 810. Sensors may provide external signals 812. Induction motor 811 may indicate electrical faults 813 which may in turn provide information related to stator 815 and rotor 816 of machine 810. Both induction motor 811 and external signals 812 may provide information related to mechanical faults 814 which can be used to predict failure conditions directly including detecting eccentricity 817.

The information related to stator 815 and rotor 816 may be used to detect failures such as rotor rub, winding failures, broken rotor bars, and end ring damage, as just a few examples. Information related to mechanical faults 814 may include failures related to bearings, belts and gears, resonance, soft foot, misalignment and unbalance, pump cavitation and blockage, looseness, and eccentricity, as just a few examples.

Fault detection environment 800 is provided for purposes of example only. Machine 810 may represent any machine comprising rotating mechanisms that may be powered by a motor drive in accordance with embodiments of the present technology. The types of information and sources of information shown in FIG. 8 are not intended to limit the technology but to provide an example of how data signals may provide a means for fault detection for rotating machinery.

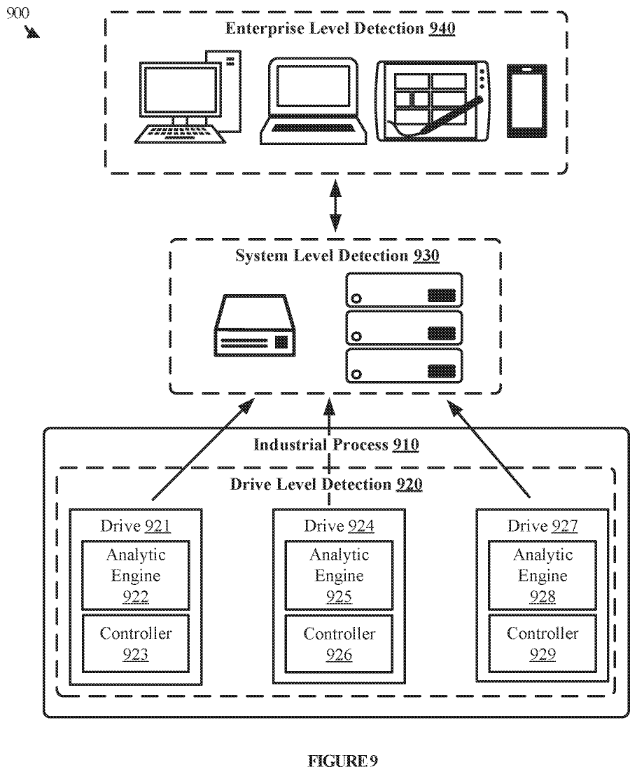

FIG. 9 illustrates an example of an industrial enterprise environment comprising multiple levels of fault detection in which embedded drive analytics may be utilized in accordance with some embodiments of the present technology. Industrial enterprise environment 900 includes industrial process 910, drive level detection 920, system level detection 930, and enterprise level detection 940. Industrial process 910 comprises drive level detection 920. Industrial process 910 may comprise any number of components, machines, subsystems, controllers, drives, encoders, and similar aspects that may make up an industrial process that can be monitored, at least in part, by an embedded analytic engine in accordance with the present disclosure.

Drive level detection 920 includes three drives, drive 921, drive 924, and drive 927, in the present example, but may comprise any number of drives associated with industrial process 910. Drive 921, drive 924, and drive 927 each represent a variable frequency drive in the present embodiment. Drive 921 comprises analytic engine 922 and drive controller 923, drive 924 comprises analytic engine 925 and drive controller 926, and drive 927 comprises analytic engine 928 and drive controller 929. However, VFDs associated with industrial process 910 may comprise any number or variety of components. Additionally, some drives may not include an analytic engine or a controller. Drive 921, drive 924, and drive 927 may each power a different component of industrial process 910 in the present example. Thus, each analytic engine in drive level detection 920 may perform condition monitoring on different data sets associated with different machinery and sensors. Condition monitoring as performed by analytic engine 922, analytic engine 925, and analytic engine 928 may be performed by any or several of the analytic engine system architectures discussed in reference to the preceding Figures including but not limited to FIG. 2, FIG. 3, FIG. 4, and FIG. 5.

Drive level detection performed by analytic engine 922, analytic engine 925, and analytic engine 928 includes monitoring fault conditions of an industrial operation to which drive 921, drive 924, and drive 927 supply power. Monitoring fault conditions may include monitoring conditions of a motor, a mechanical load, and variations or combinations thereof. Drive level detection may include power and energy monitoring such as tracking power consumption and identifying energy usage trends. Drive level detection may further include predictive life analysis, component integrity analysis, environmental condition analysis, monitoring failure rates, capturing machine dynamics, detecting abnormal behavior, monitoring the effects of material changes, and load characterization such as performance benchmarking, digital twin analysis, adaptive control, preventative maintenance, and energy diagnostics.

Analytic engine 922, analytic engine 925, and analytic engine 928 may produce signal data, metrics, and results which are communicated to system level detection 930 in the present example. However, the analytic engines may communicate signal data, metrics, and results that are communicated to additional locations, such as a gateway to enterprise level detection 940 or other locations. System level detection may comprise any computers, systems, servers, or other machines capable of processing the data from the drives based on instructions and may include one or more machine learning techniques to perform condition monitoring. In some examples, devices of system level detection 930 may be on-site systems such as PLC automation controllers that are physically connected to the drives, while in other examples, data may be communicated by other means such as Bluetooth, internet, ethernet, and similar network-based communication means. System level detection 930 may then use metrics from individual drives to perform additional processing to detect fault conditions that arise across a number of drives and devices connected to a PLC automation controller. System level detection 930, in some examples, employs one or more machine learning techniques to detect failures, monitor conditions, or analyze results from data provided by the drives.

Drive level detection is used in applications where a single stand-alone drive is deployed, or fault conditions are related to individual drive systems. However, system level detection is used in applications where multiple drives and devices are interconnected to a PLC automation controller, i.e. a machine, or fault conditions are related to the interconnected system or machine.

System level detection serves as an additional detection layer and may include, similar to drive level detection, preventative maintenance for reducing unscheduled downtime, preventing catastrophic failures, and streamlining inventory, and may further include energy diagnostics, system modeling, and performance optimization. The system level detection may help to improve efficiency, reduce operating costs, extend machine life, perform high fidelity simulations and emulations, perform digital twin modeling, verify functionality, predict expected performances, simulate fluctuations, perform mechanical analysis, perform sizing analysis, recommend settings, identify configuration issues, optimize utilization, and identify motion profiles trends.

System level detection 930 may further communicate with enterprise level detection 940 that is used to locate and identify problems across a group of systems or machines. Enterprise level detection may be used for remote monitoring with desktop computers, tablets, cell phones, laptops, and other computing devices through which users may monitor conditions via one or more applications associated with the industrial enterprise. Enterprise level detection may include processing trends, machine learning techniques, pattern recognition analysis, expected performance, failure prevention, and root cause analysis, wherein root cause analysis may serve to reduce repair time, reduce common problems, identify the worst problems, and process bottlenecks.

The functions discussed with respect to each of level of detection shown in FIG. 9 are described here solely for purposes of example. Additional functionality at each level may exist, and each level may be purposed for functions that differ from the functions described herein. In addition, functionalities described herein may be performed at different levels than described in the present example. The present technology provides the flexibility to customize information for specific applications with the modular topology described herein in which the configurable analytics processor operates as the foundational building block on which application layers may be built on top of to hide complexity and simplify the user experience.

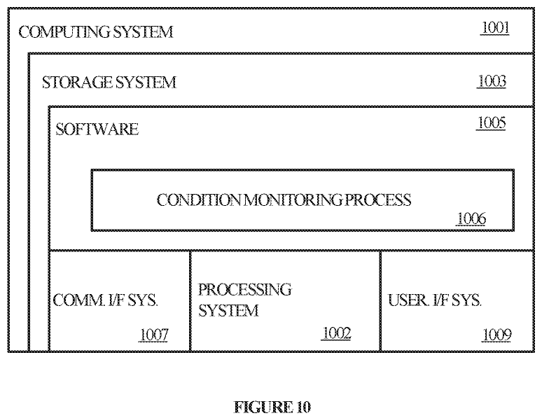

FIG. 10 illustrates computing system 1001 to perform condition monitoring according to an implementation of the present technology. Computing system 1001 is representative of any system or collection of systems with which the various operational architectures, processes, scenarios, and sequences disclosed herein for condition monitoring may be employed. Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements condition monitoring process 1006, which is representative of the condition monitoring processes discussed with respect to the preceding Figures. When executed by processing system 1002 to provide condition monitoring functions, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including condition monitoring process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing an embedded analytic engine for motor drives system as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 1001 is representative) overall from a general-purpose computing system into a special-purpose computing system customized to provide drive embedded condition monitoring as described herein. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of an embedded analytic engine, it should be understood the condition monitoring systems and methods described herein are not limited to such embodiments and may apply to a variety of other condition monitoring environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. An industrial drive comprising:
drive circuitry configured to supply power to a motor in an industrial operation;
a controller coupled with the drive circuitry and configured to control the power supplied to the motor based at least in part on runtime signal data associated with the motor; and
a condition monitoring module configured to:
obtain the runtime signal data from the controller; and
monitor one or more fault conditions of the industrial operation based on metrics comprising runtime metrics derived from the runtime signal data and baseline metrics derived from baseline signal data.

2. The industrial drive of claim 1, wherein the condition monitoring module is further configured to:
identify a fault condition, of the one or more fault conditions, to be monitored;
derive the runtime metrics from the runtime signal data based on settings specific to the fault condition; and
derive the baseline metrics from the baseline signal data based on the settings.

3. The industrial drive of claim 2, wherein the settings specific to the fault condition comprise one or more of filter settings, time domain parameters, frequency domain parameters, transform settings, and pattern recognition settings.

4. The industrial drive of claim 2, wherein the condition monitoring module is further configured to:
obtain the baseline signal data prior to obtaining the runtime signal data;
store the baseline signal data in the industrial drive; and
synchronize the baseline signal data with the runtime signal data.

5. The industrial drive of claim 4, wherein the condition monitoring module is further configured to, when a new motor replaces the motor:
obtain new baseline signal data;
store the new baseline signal data in the industrial drive; and
synchronize the new baseline signal data with the runtime signal data.

6. The industrial drive of claim 1, wherein to monitor one or more fault conditions of the industrial operation, the industrial drive is configured to:
generate differential metrics based on the runtime metrics and the baseline metrics; and
supply at least the differential metrics to a detection engine to detect a presence of the one or more fault conditions.

7. The industrial drive of claim 6, wherein the detection engine comprises at least one machine learning model configured to classify a condition of the industrial operation based on the differential metrics.

8. One or more computer-readable storage media having program instructions stored thereon to perform condition monitoring in an industrial automation environment, wherein the program instructions, when read and executed by a processing system, direct the processing system to at least:
in a motor drive configured to supply power to a motor in an industrial operation, obtain runtime signal data from one or more sensors associated with the industrial operation;
in the motor drive, derive runtime metrics from the runtime signal data based on settings specific to a fault condition of the industrial operation; and
in the motor drive, monitor the fault condition of the industrial operation based on metrics comprising the runtime metrics derived from the runtime signal data and baseline metrics derived from baseline signal data.

9. The one or more computer-readable storage media of claim 8, wherein the program instructions, when read and executed by the processing system, further direct the processing system to:
in the motor drive, identify the fault condition to be monitored; and
in the motor drive, derive the baseline metrics from the baseline signal data based on the settings.

10. The one or more computer-readable storage media of claim 9, wherein the settings specific to the fault condition comprise one or more of filter settings, time domain parameters, frequency domain parameters, transform settings, and pattern recognition settings.

11. The one or more computer-readable storage media of claim 9, wherein the program instructions, when read and executed by the processing system, further direct the processing system to:
in the motor drive, obtain the baseline signal data prior to obtaining the runtime signal data;
in the motor drive, store the baseline signal data in a drive associated with the industrial operation; and
in the motor drive, synchronize the baseline signal data with the runtime signal data.

12. The one or more computer-readable storage media of claim 11, wherein the program instructions, when read and executed by the processing system, further direct the processing system to, when a new motor replaces the motor:
in the motor drive, obtain new baseline signal data;
in the motor drive, store the new baseline signal data in the drive associated with the industrial operation; and
in the motor drive, synchronize the new baseline signal data with the runtime signal data.

13. The one or more computer-readable storage media of claim 8, wherein the program instructions, when read and executed by the processing system, further direct the processing system to:
in the motor drive, generate differential metrics based on the runtime metrics and the baseline metrics; and
in the motor drive, supply at least the differential metrics to a detection engine to detect a presence of the fault condition.

14. The one or more computer-readable storage media of claim 13, wherein to detect the presence of the fault condition, the program instructions, when read and executed by the processing system, further direct the processing system to classify a condition of the industrial operation based on the differential metrics using a machine learning model.

15. A method of condition monitoring in an industrial automation environment, the method comprising:
obtaining runtime signal data in a drive configured to control power supplied to a motor in an industrial operation based at least in part on the runtime signal data associated with the industrial operation;
deriving runtime metrics from the runtime signal data based on settings specific to a fault condition of the industrial operation; and
monitoring the fault condition of the industrial operation based on metrics comprising the runtime metrics derived from the runtime signal data and baseline metrics derived from baseline signal data.

16. The method of claim 15, further comprising:
identifying the fault condition to be monitored; and
deriving the baseline metrics from the baseline signal data based on the settings.

17. The method of claim 16, wherein the settings specific to the fault condition comprise one or more of filter settings, time domain parameters, frequency domain parameters, transform settings, pattern recognition settings, and frequency response settings.

18. The method of claim 16, further comprising:
obtaining the baseline signal data prior to obtaining the runtime signal data;
storing the baseline signal data in a drive associated with the industrial operation; and
synchronizing the baseline signal data with the runtime signal data.

19. The method of claim 18, further comprising, when a new motor replaces the motor:
obtaining the baseline signal data prior to obtaining the runtime signal data;
storing the baseline signal data in the drive associated with the industrial operation; and
synchronizing the baseline signal data with the runtime signal data.

20. The method of claim 15, further comprising:
generating differential metrics based on the runtime metrics and the baseline metrics; and
supplying at least the differential metrics to a detection engine to detect a presence of the fault condition.
